(19) United States
(12) Patent Application Publication
(10) Pub. No.: US 2002/0110796 A1
(43) Pub. Date: Aug. 15, 2002

(54) Internet learning support system by computer system

(75) Inventors: Takashi Sugano, Yokohama-shi (JP); Takayuki Motoyama, Tokyo (JP)

Correspondence Address: KANESAKA AND TAKEUCHI, 1423 Powhatan Street, Alexandria, VA, 22314, US

(73) Assignee: T. I. S. Inc.

(21) Appl. No.: 09/879,935

(22) Filed: Jun. 14, 2001

(30) Foreign Application Priority Data
Jun. 26, 2000 (JP) 2000-191682

(51) Int. Cl. G09B 3/00

(52) U.S. Cl. 434/350

(57) ABSTRACT

The invention provides an Internet learning support system by a computer system by which preparation of questions, collection of answer sheets, and totalization can be totally managed.

A server (school) automatically selects teaching materials suitable for a student from a teaching materials database (Step 2), and sends exercise data to a personal computer of the client (student) (Step 3), and the student directly writes answers into the sent exercise data and returns the data to the server (school) (Step 8). The server (school) opens the answer data sent from the student on the screen of the computer, adds corrections into the data (Step 10), and registers the corrected data (Step 12), whereby processes from preparation of exercises for students to preparation of data on students' understanding conditions are totally managed.

### BACKGROUND OF THE INVENTION

1. Field of the Invention

The present invention relates to a system for supporting student learning by using a computer network system, that is, a so-called network correspondence course system.

2. Description of the Related Art

In a conventional correspondence course system, support of learning by students (pupils) is carried out by the following procedures. That is, the school side selects teaching materials for each learning curriculum and field of correspondence courses, determines the deadline of answers, and mails assignments and answer sheets to students, on which questions of the teaching materials have been printed.

Students answer the questions on the assignments, write answers on the answer sheets, and meet deadlines for mailing the answer sheets to the school. The school side receives the answer sheets mailed from the students, and requests appointed teachers to correct the answers. The appointed teachers correct with red pens the answers on the answer sheets mailed from the students, and return the answer sheets to the school side with score records and comments attached to them.

The school side totals the answers that were mailed and returned by all the students, and based on the results of totalization, prepares information including the ranking of the students and judgement results on the passing possibilities of entrance examinations of schools of the students' choices, and mails the information to the students together with the corrected answer sheets. Furthermore, the school side stores the information and uses the information to prepare learning curriculums and grasp the degree of understanding of the students for each subject.

When the abovementioned system is used, the school side is required to perform a large amount of work including sending of assignments and answer sheets to each student, classification of answer sheets returned from the students, requests to teachers for correction of answers, totalization of answers, preparation of information, and provision of information for each student, and return of answer sheets to students. In addition, if the postal system or home delivery service is used as the transportation means between the school and students, it takes much time to make communication between them.

Of course, at present, even though the delivery means such as the postal system or home delivery service is not always used, communication between the school and students can be made by facsimile and e-mail, so that the time for communication can be significantly shortened by use of facsimile and e-mail. Furthermore, if software exclusive for totalization of answer sheets returned from students is prepared, totalization, output of judgement results, and preparation and output of various information can be carried out by using a computer in a relatively short time.

However, even if the communication between the school and students is made by facsimile and e-mail, and furthermore, answer sheets returned from the students are totalized by using exclusive software of a computer, works such as preparation of questions and input of answer data written on answer sheets into the computer are still carried out by man power.

### SUMMARY OF THE INVENTION

The object of the invention is to provide an Internet learning support system through a computer system which totally manages preparation of questions, collection of answer sheets, and totalization without requiring man power.

In order to achieve the abovementioned object, the Internet learning support system through a computer system according to the invention is a system in which a school computer that is a server using a computer network system provides learning support to computers of students who are clients, and which comprises teaching material selection processing, exercise data sending processing, answer data receiving processing, correction processing, corrected data registration processing, and corrected data sending processing, wherein

the teaching material selection processing automatically selects teaching materials suitable for each student from a teaching materials database based on the information on the degree of understanding of each learning curriculum and field of the student stored in a system information database;

the exercise data sending processing specifies the student, prepares an e-mail for the student, attaches the selected exercise data to the e-mail and sends the e-mail to the student, and urges the student to return the answer;

the answer data receiving processing receives the answers to the exercise data from the student by e-mail, and opens the answer data attached to the answer mail;

the correction processing is for adding corrections to the answer data, where the corrections are directly written into the opened answer data by handwriting using a pad, pen or mouse on the screen of the computer;

the corrected data registration processing stores the corrected data for each student, which is temporarily stored in a temporary directory, into a sending history database; and

the corrected data sending processing displays a sending list from the sending history database, automatically prepares an e-mail with the contents of the sending history and the corrected data attached to it for each student, and sends the mail to the student, and stores the sending record into the sending history database.

In addition, to automatically prepare teaching materials suitable for the student from the teaching materials database, the teaching material selection processing includes processing for preparing questions by randomly combining the questions stored in the teaching materials database by levels and subject field units.

Furthermore, the teaching material selection processing selects questions of each categorized level based on the condition of the degree of understanding of a student in accordance with the understanding degree judging information of the student, which compares the subject name, unit name, field name, and score of a student stored in a student results database with the teaching materials database, and based on the results of this comparison, randomly extracts questions belonging to the corresponding subject, unit, and field, and extracts several questions in order of highest priority when preparing questions while excluding the finished questions of the student in accordance with the student results database.

In the correction processing, corrections are added to answer data sent from the student by handwriting using a pad, pen or mouse on the screen of the computer, the computer is made to recognize the handwritten characters, whereby the answer data is directly corrected by handwriting. In addition, in the correction processing, specifications of the line thickness and color and input of printing type are freely carried out on the keyboard, and when an error is in the written correction, even if the contents of the correction are deleted by using an eraser function, the answer data by the student is left as it is, and only the correction made by a teacher is deleted.

The corrected data sending processing includes processing whereby, when the name and e-mail address of a student are displayed interlocked with a student information database upon an input of the student's ID code into an input device, and the unit, field, and name of the corrector of the correction are inputted, these records are stored in the sending history database together with the corrected data.

The school server using a computer network sends exercise data to the computer of a student who is a client, and the student can directly write answers into the exercise data on the screen of his/her computer and return the data to the server computer.

Entrance processing is further provided, wherein

entrance formalities are directly accepted at the school's window, and in addition, accepted by e-mail and facsimile, and the contents of the application form are converted into a text format and imported into a database.

The Internet learning support system by a computer network system according to the invention provides learning support to a computer of a student, who is a client, from a computer of a school, which is a server, by using a computer network system, wherein the server computer, which carries out teaching material selection processing, exercise data sending processing, answer data receiving processing, correction processing, corrected data storage processing, and corrected data sending processing, has databases including a teaching materials database, student system information database, student results database, and sending history database, wherein

information stored in the teaching materials database includes:

1. subject names (names of class materials categorized by pedagogical objective and method and degree of the students' development), 2. unit names (items to be learned in each subject), 3. field names (items to be learned in each unit), 4. levels (difficulty of questions in teaching materials), 5. question ID codes, 6. question files, 7. answer files, 8. the order of priority (the order of extraction of questions in teaching materials);

information stored in the student results database includes:

1. student ID codes, 2. student names, 3. subject names (names of class materials categorized by pedagogical objective and method and degree of the students' development), 4. unit names (items to be learned in each subject), 5. field names (items to be learned in each unit), 6. scores, and 7. finished question ID codes;

information stored in the sending history database includes:

1. student ID codes, 2. student names, 3. correction dates, 4. subject names, 5. unit names, 6. field names, 7. corrector names and 8. sending condition (distinction between unsent and sent).

### BRIEF DESCRIPTION OF THE DRAWINGS

FIG. 1 is a diagram showing the system configuration of the invention;

FIG. 2 is a block diagram showing the configuration of the server;

FIG. 3 is a flowchart showing the action of an embodiment;

FIG. 4 is a drawing showing automatic selection procedures of teaching exercise materials; and

FIG. 5 is a diagram of the configuration of the learning support system for clients.

### DETAILED DESCRIPTION OF THE PREFERRED EMBODIMENT

Hereinafter, an embodiment of the Internet learning support system by a computer system is explained with reference to the drawings. In the invention, a school system is a server, and a student is a client. The school is not limited to a regular school, but may be a vocational school, private supplementary school, or cram school.

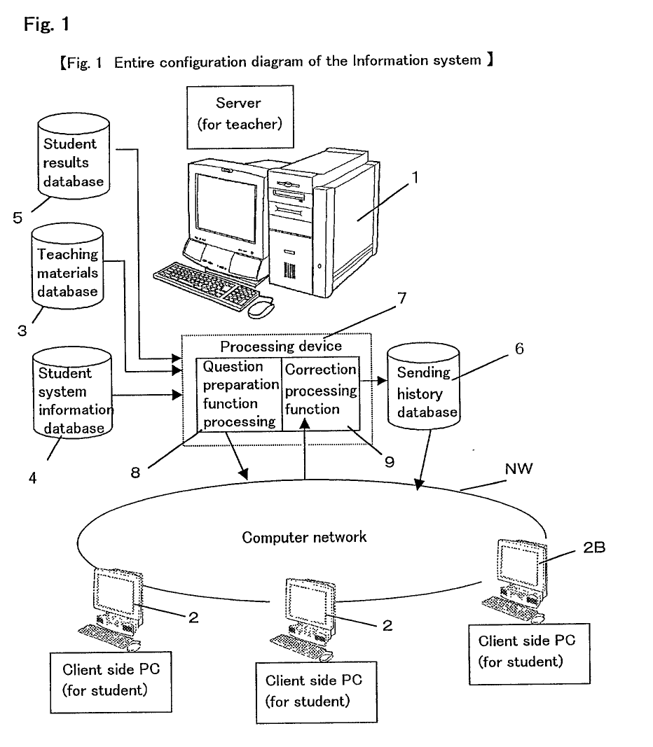

In FIG. 1, computer 1 of a server (school) is connected to the computer network NW via a line control device and a telephone line, and computers (personal computers) 2, 2 . . . of clients (students) are connected to the computer 1 of the server (school) via the computer network NW.

Needless to say, each personal computer 2, 2 . . . of the clients' side has a display device such as a CRT or a display and input devices such as a keyboard and a mouse. The software program of the learning support system is a set of combinations of a server side program and a client side program.

1. Configuration of the Learning Support System of the Server Computer (School)

The basic configuration the computer 1 of the server (school) made by a processing device, input devices, and output devices is the same as that of a normal server. In actuality, a personal computer is used as the server, and for distinction from the personal computers of clients, herein, the personal computer as the server is referred to as a computer. The processing device includes a CPU, and carries out control of units, transference of data, various operations, and temporary storage of data. The input devices control data inputted from the personal computers of clients via the network, and the output devices control data to be outputted to the personal computers.

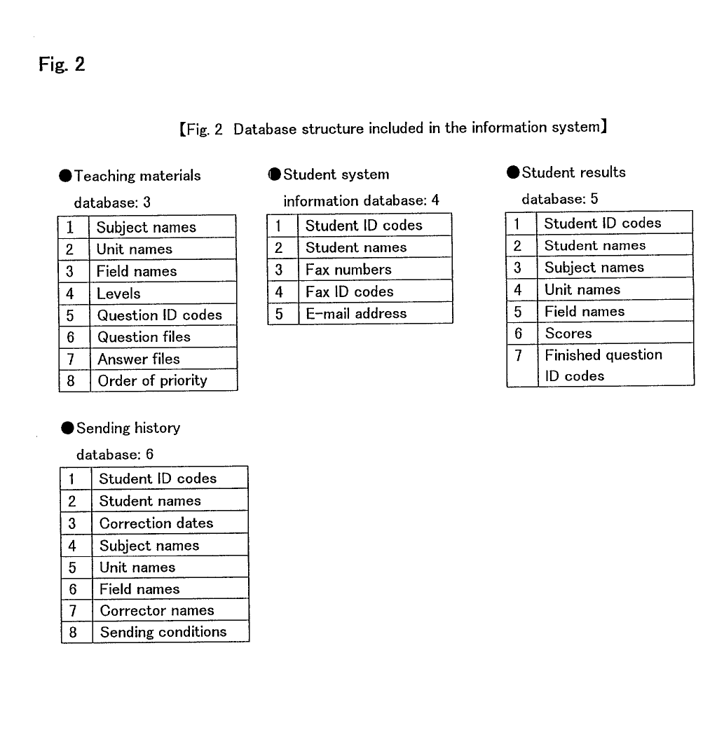

In the invention, databases in the computer 1 at the server (school) side include teaching materials database 3, student system information database 4, and student results database 5, sending history database 6, and the following information is stored in each database as shown in FIG. 2.

(1) Information Stored in the Teaching Materials Database:

1. subject names (names of class materials categorized by pedagogical objective and method and degree of the students' development), 2. unit names (items to be learned in each subject), 3. field names (items to be learned in each unit), 4. levels (difficulty of questions in teaching materials), 5. question ID codes, 6. question files, 7. answer files, 8. the order of priority (the order of extraction of questions in teaching materials)

(2) Information Stored in the Student System Information Database:

1. student ID codes, 2. student names, 3. students' facsimile numbers, 4. students' facsimile ID codes, and 5. students' e-mail addresses

(3) Information Stored in the Student Results Database:

1. student ID codes, 2. student names, 3. subject names (names of class materials categorized by pedagogical objective and method and degree of the students' development), 4. unit names (items to be learned in each subject), 5. field names (items to be learned in each unit), 6. scores, and 7. finished question ID codes;

(4) Information Stored in the Sending History Database:

1. student ID codes, 2. student names, 3. correction dates, 4. subject names, 5. unit names, 6. field names, 7. corrector names and 8. sending condition (distinction between unsent and sent).

Processing device 7 has question preparation processing function 8 and correction processing function 9, wherein the question preparation processing function 8 and the correction processing function 9 executes the following functions based on read data or data inputted from the personal computers.

A. Question Preparation Processing Function:

(1) Selecting Function for Teaching Materials

Randomly combines several tens of questions data that have been prepared for each level, unit, and field and stored in the teaching database 3 based on the condition of the degree of understanding of each student in his/her learning curriculum and each unit and field of each subject.

(2) Sending Function of Exercise Data

Prepares e-mails addressed to each student to which exercise data has been attached with reference to the student system information database, and automatically sends the e-mails.

B. Correction Processing Function:

(1) Answer Data Receiving Function

Receives answer data sent from a student into which the student has written answers, and opens the attached answer data file when the attached file is double-clicked.

(2) Students' Understanding Condition Judging Function

Conducts tests for checking the understanding degree for each subject, unit, and field, judges the student's understanding condition and calculates the times required to finish the subject, unit, and field, and divides judgement results and calculation into five levels.

(3) Corrected Data Sending Function

Based on the sending history database, the sending list to students is displayed on the screen.

When a student name indicated in the list is double-clicked, the corrected data sending function automatically prepares an e-mail to which the corrected unit, correction date, corrector name, and compressed corrected data have been attached and sends the e-mail to the personal computer of the student.

(4) Function for Reflecting the Handwriting by Pen or Mouse

Sets the axis of coordinates on the pad and screen, records information on the positions of written characters and lines as coordinates, and draws them in the specified colors and thicknesses. This function is used when a teacher adds corrections and comments into answer data returned from a student into which the student has written answers.

(5) Eraser Function

When the teacher makes a mistake in adding corrections and comments, does not delete the student's answers, but deletes only specified contents of corrections and comments. This function is used when a teacher adds corrections and comments into answer data returned from a student into which the student has written answers.

3. Configuration of the Learning Support System of the Personal Computers of Clients (Students)

The basic configuration of the personal computer of each student made by a processing device, input devices, output devices, and databases is the same as that of the computer of the server (school).

The processing device includes a CPU, controls the units, and carries out transference of data, various operations, and temporary storage of data, the input devices control data inputted from the server via the network, and the output device controls data to be outputted from the personal computer of the student to the server.

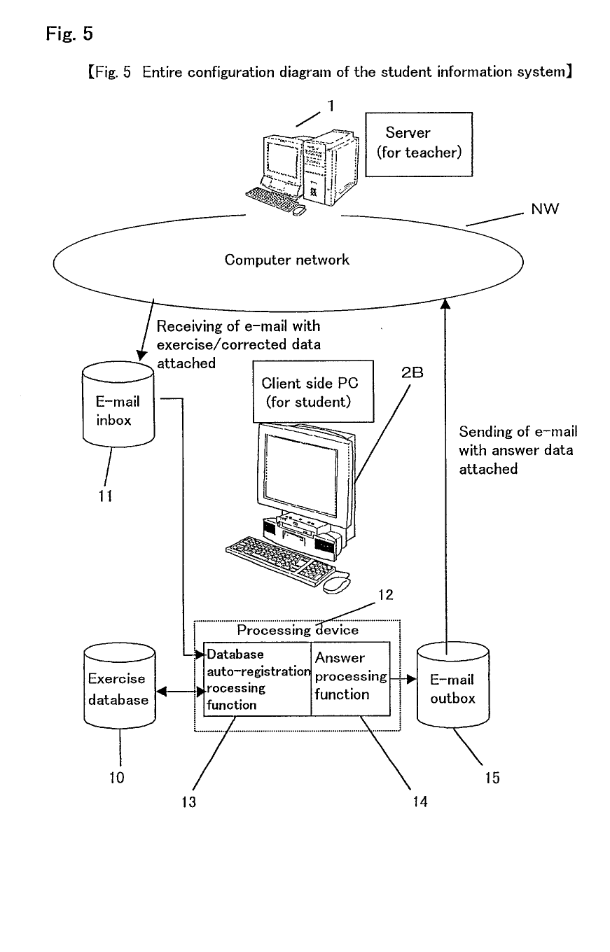

In FIG. 5, exercise database 10 is provided, in which exercise data and corrected data corrected by teachers that have been sent from the server (school) 1 are stored. The exercise data and corrected data corrected by teachers that have been sent from the server (school) 1 are processed by the processing device 12. The processing device 12 mainly has database automatic registration processing function 13 and answer processing function 14, by which the following functions are executed.

A. Database Automatic Registration Processing Function:

(1) Storing Function of Corrected Data/Exercise Data

Corrected data/exercise data sent from the server (school) 1 is received by the e-mail receiving box 11. Since corrected data/exercise data is compressed to reduce the sending capacity, the data is stored in exercise database 10 by this function when the data is dragged and dropped into the exercise database 10.

(2) Extracting Function of Exercise Data

Searches an object data, decompresses the data that has been compressed and stored, and extracts the out of the exercise database 10 when the subject, unit, date and others are inputted.

(3) Corrected Data Receiving Function

Receives corrected data that has been compressed and sent and stores it into the exercise database.

B. Answer Processing Function:

(1) Function for Reflecting Handwriting by a Pen or Mouse

Sets the axis of coordinates on the pad and screen, records positional information of the written characters and lines as coordinates, and draws them in the specified colors and thicknesses. This function is used when a student writes answers into the exercise data.

(2) Eraser Function

When the student makes a mistake in writing answers, only the contents of answers that are specified for correction are deleted.

(3) Answer Data Sending Function

Answer data is data in which the student added answers into the exercise data extracted from the exercise database 10. By this function, an e-mail to which the answer data has been attached is automatically prepared and sent from the e-mail sending box 15 to the server 1.

4. Explanation of Action

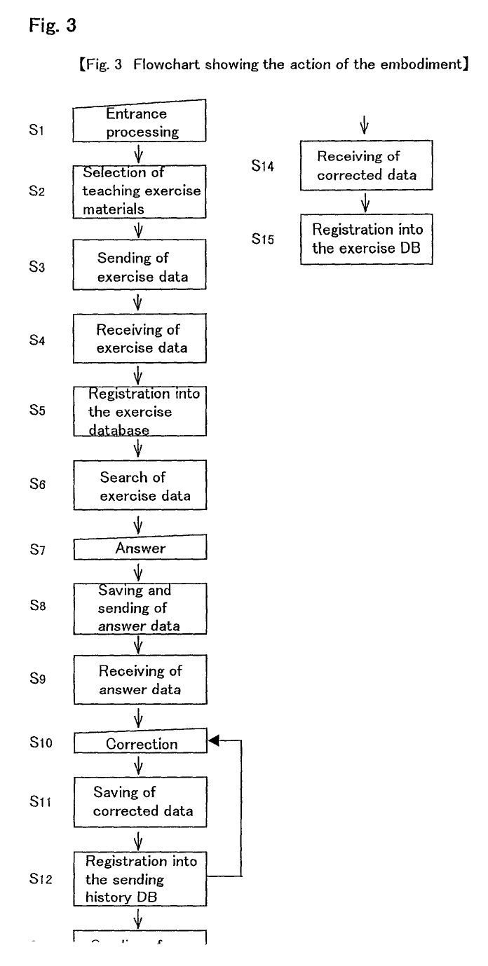

Hereinafter, the action of the invention is explained with reference to the flowchart of FIG. 3. First, personal computers 2, 2 . . . of clients (students) in which the system of the invention has been introduced make communication with the computer 1 of the server (school) via the computer network NW, and function as terminals for receiving exercise data and corrected data. In the following description, the communication between the server 1 and a specific student's personal computer 2B is explained with reference to the flowchart of FIG. 3.

4-1. Entrance Processing (Step 1)

The school accepts applications for admission, and registers private information including new student names, addresses, ages, e-mail addresses, and ID codes into the student system information database. In addition, the school issues ID codes exclusive for each student, conducts tests, judges the understanding conditions of the students, and registers the conditions into the student system information database for each student. The abovementioned procedures are performed by the OCR processing of the server. The entrance formalities are directly accepted by the window of the school, or accepted by e-mails or facsimile, and the contents entered in the application form are converted into a text format and imported into the student system information database 4. Then, the school delivers execution functions of the processing device 12 to the personal computers 2B of students who have completed the entrance formalities. Thereafter, the students use the issued ID codes to make communication with the server via the computer network.

4-2. Teaching Exercise Material Selection Processing (Step 2)

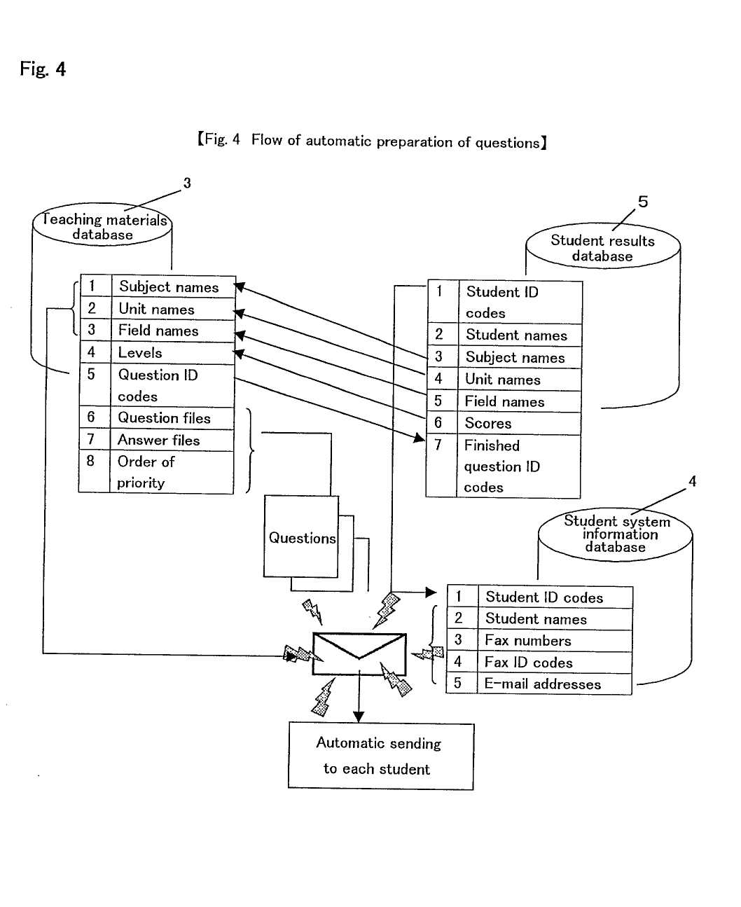

Based on the understanding condition information of each student about each learning curriculum and field stored in the student system information database, the schools automatically select teaching materials suitable for the student from teaching materials database. The automatic selection processing randomly combines several tens of questions for each level and unit in the teaching materials database to prepare questions. The teaching material selection processing selects questions according to the five levels categorized based on the students' understanding condition information obtained by executing the students' understanding condition judging function, and at the initial time when the data is not prepared yet, the teaching materials selection processing is not carried out, but the same questions are distributed to the students. The selection processing procedures are explained with reference to FIG. 4.

In FIG. 4, first, the subject name, unit name, field name, and score of a student stored in the student results database 5 are compared with the teaching materials database 3, and based on the results of this comparison, several tens of questions belonging to the corresponding subject, field, and unit are randomly extracted. When preparing questions, several questions are extracted in the order of higher priority while excluding finished questions in the student results database 5. The student ID code of the student results database 5 is compared with the student ID code of the student information database 4, and the student's name, facsimile number or email address that are required for sending are acquired, and a sending mail is prepared by attaching the subject name, unit name, field name, and automatically prepared questions from the teaching materials database 3 to the mail.

4-3. Exercise Data Sending Processing (Step 3)

The school automatically prepares an e-mail addressed to a student upon selecting the student ID code or the student name, attaches selected exercise data to the e-mail and sends it to the student, and urges the student to return answers. The sent exercise data is transmitted to the student's personal computer 2B as an e-mail via the computer network (the Internet or the like). The sending mail is sent to each of the students' personal computers 2, 2 . . . at every fixed time.

4-4. Exercise Data Receiving Processing (Step 4)

The student drags and drops the exercise data transmitted from the server 1 to his/her personal computer into the exercise database.

4-5. Exercise Data Registration Processing (Step 5)

The student registers the sent data into the exercise database 10 of his/her personal computer.

4-6. Exercise Search Processing (Step 6)

The student searches exercise data for which he/she should study by means of database items (date, subject, and field) from the exercise database installed in the software of the learning support system, extracts the targeted exercise data, and opens the data.

4-7. Answer Processing (Step 7)

The exercise data opened in Step 5 is displayed on the screen of the personal computer 2B, and the student writes answers on the screen of the personal computer 2B by handwriting with a pad, mouse and pen. The learning support system recognizes the handwriting and directly reflects the handwritten data to the exercise data (the line thicknesses and colors can be freely set). In the software of the learning support system, even when the handwriting speed is the same as that of the handwriting on a normal piece of paper, the handwriting is immediately and securely displayed.

In the case of normal drawing (display) processing, since the whole page is subjected to drawing processing again, the drawing speed cannot follow the handwriting speed, however, in the learning support system of the invention, a structure is used to manage coordinates (regard the positions of handwritten characters and lines as two-dimensional coordinates, and temporarily store the handwriting order and coordinate positions in the memory of the computer), and only the handwritten portions are subjected to drawing processing again, whereby the processing at the same speed as the handwriting speed is made possible.

4-8. Answer Data Saving and Sending Processing (Step 8)

When a student finishes an answer, selects the save menu to actuate the answer data/exercise data saving function, and saves the answer data to which handwritten answers are added, an e-mail to which the answer data has been attached is automatically prepared, and the answer data is sent from the personal computer 2B to the server 1. At the same time, the answer data is automatically registered in the exercise database. Thereby, the exercise data sent from the server 1 and the answer data are registered in the exercise database 10 in the student's personal computer. The answer data may be returned to the server 1 by facsimile.

4-9. Answer Data Receiving Processing (Step 9)

The answer data sent via the computer network (the Internet) NW is transmitted from the student's personal computer 2B to the computer 1 of the server (school) as an e-mail.

At the server side, the e-mail sent from the student is opened, and the attached answer data is double-clicked. Thereby, the software of the learning support system is started, and the student's answer data is opened. The software of the learning support system of the invention uses the TIFF format, BMP format and others, and when the attached file is double-clicked, the software of the learning support system is started, and the file is immediately opened, so that the process to temporarily save the file in the personal computer can be omitted. When the answer data is sent by facsimile, the data is taken into the computer as image data, and processed in the same manner as mentioned above.

4-10. Correction Processing (Step 10)

When a teacher adds corrections to the answer data opened by the learning support system on the screen of the computer by handwriting with a pad, mouse and pen, the learning support system recognizes the handwriting, whereby the answer data can be directly corrected by handwriting. The printing type input such as the line thicknesses and colors can be freely set by the keyboard, and in addition, even when the teacher makes a mistake in writing corrections and deletes the corrections by using the eraser function, the student's answer data is not deleted, and only the corrections by the teacher are deleted. In the learning support system of the invention, a filter is applied onto the data into which answers to be corrected have been written (in graphic terms, a layer is added on the data), the added corrections are not directly reflected, but are added onto the filter, so that the student's answers are not deleted by the eraser function. When the data is saved, the added corrections are reflected to the data (this function is referred to as layer integration).

4-11. Corrected Data Saving Processing (Step 11)

When correction of the answer data is finished, and the save menu is selected, the corrected data into which handwritten corrections have been added is saved in the temporary directory (directory for temporarily storing the data before registration into the sending history database)

4-12. Registration Processing into the Sending History Database (Step 12)

When the corrected data saving processing is completed, the sending history database registration screen is started, and when the student ID code is inputted into the input device, it is interlocked with the student system information database 4 and displays the student's name and e-mail address. When the teacher inputs the correspondence course unit and field, and his/her name and presses the button, these records are registered into the sending history database 6. This processing is carried out for all data returned from students. The record of the e-mail sent to the student in the next corrected data sending processing is also saved in the sending history database 6.

4-13. Corrected Data Sending Processing (Step 13)

When correction of all answer data sent from the student is completed, the sending list is automatically displayed from the sending history database 6, and when the corresponding student's name is double-clicked, an e-mail with corrected data attached is automatically prepared, the mail is sent to the student via the computer network, and a record of this sending is saved into the sending history database 6.

Even after that, the server side can freely call the student's corrected data from the sending history database 6, further add corrections into the called corrected data, and print-out the corrected data and the sending history of corrected data to the student.

4-14. Corrected Data Receiving Processing (Step 14)

The corrected data sent from the server side is received by the student's personal computer 2B as an e-mail via the computer network (the Internet or the like).

4-15. Corrected Data Receiving Processing (Step 15)

The student drags and drops the corrected data received by the personal computer 2B into the exercise database 10 to register the corrected data. The returned corrected data can be called from the exercise database and printed out as necessary. By selecting the corrected data saved in the exercise database and using the preview function of the software of the learning support system, the student can confirm the corrected data, and attempt to answer the erroneous question again and send it again to the server side by Step 8.

In the invention, when carrying out the automatic receiving processing of the exercise data and answer data at the student side in Steps 4 and 9, upon starting the learning support system by the client side, existence of exercise and answer data in the inbox is checked, and if it is in the inbox, the data is automatically taken and registered into the exercise database.

In Step 9, when the answer data is received at the server side, upon starting the learning support system, the existence of exercise and answer data in the e-mail inbox within the computer is confirmed, and if there is answer data, the data is automatically taken in and opened on the correction screen. All mail sent from students are read and the button is pressed, files attached to the read data from all students can be successively opened on the correction screen.

As described above, according to the invention, by using the computer network, a server (school) can send exercise data to the personal computers of clients (students), the students can directly write answers into the exercise data on their personal computers and return the data to the server, whereby instantaneous communication can be obtained between the school and students.

Furthermore, based on the understanding condition of each student about questions of each level unit in the teaching materials database, each learning curriculum and field, teaching material suitable for each student is automatically selected from the teaching materials database, and the answer data after being corrected is saved, whereby preparation of learning exercises for each student and data of the understanding condition of each student can be totally managed, the answer data sent from a student can be opened on the screen of the computer, and corrections can be directly added into the data by handwriting with a pad, mouse and pen. Therefore, works of correction and preparation of data of students' understanding conditions can be rationally carried out.

What is claimed is:

1. An Internet learning support system by a computer system which provides learning support to computers of students, who are clients, from a server computer of a school, and comprises teaching material selection processing, exercise data sending processing, answer data receiving processing, correction processing, corrected data registration processing, and corrected data sending processing, wherein
the teaching material selection processing automatically selects teaching materials suitable for each student from a teaching materials database based on the understanding condition information of each student about each learning curriculum and field stored in the system information database;
the exercise data sending processing specifies a student, prepares an e-mail addressed to the student, sends the e-mail to the student upon attaching the selected exercise data to the mail, and urges the student to return answer data;
the answer data receiving processing receives answers to the exercise data sent from the student by e-mail, and opens the attached answer data;
the correction processing directly adds corrections into the opened answer data by means of handwriting with a pad, mouse and pen on the screen of the computer;
the corrected data registration processing registers corrected data of each student, which has been saved in a temporary directory after correcting the answer data, into the sending history database; and
the corrected data sending processing displays a sending list from the sending history database, automatically prepares an e-mail for each student to which the contents of the sending history and corrected data have been attached, sends the e-mail to the student, and saves the sending record into the sending history database.

2. An Internet learning support system by a computer system according to claim 1, further comprising processing which prepares questions by randomly combining questions for each subject, field, unit and level stored in the teaching materials database when automatically preparing teaching materials suitable for the student from the teaching materials database.

3. An Internet learning support system by a computer system according to claim 1, wherein the teaching material selection processing selects questions in accordance with the levels categorized based on the understanding condition of each student that can be judged from the students' understanding condition judgement information, and in this processing, the subject name, unit name, field name, and score of the student stored in a student results database are compared with the teaching materials database, and based on the results of this comparison, questions belonging to the corresponding subject, field, and unit are randomly extracted, and to prepare questions, several questions are extracted in the order of highest priority while excluding the finished questions in the student results database.

4. An Internet learning support system by a computer system according to claim 1, wherein, in the correction processing, corrections are added into answer data returned from the student by handwriting with a pad, mouse and pen on the screen of the computer, the computer is made to recognize the handwritten characters, whereby corrections are directly added into the answer data by handwriting, and specifications of line thicknesses and colors and the printing type input by a keyboard are freely carried out, and when the corrector (teacher) makes a mistake in writing corrections, even if he/she deletes the contents of the erroneous correction by using the eraser function, the student's answer data is not deleted, and only the erroneous correction is deleted.

5. An Internet learning support system by a computer system according to claim 1, wherein the corrected data sending processing includes processing whereby, when the student ID code is inputted into the input device, the input device is interlocked with the student information database and the student's name and e-mail address are displayed, and when the corrected unit, field, and corrector name are inputted, the records are saved into the sending history database together with the corrected data.

6. An Internet learning support system by a computer system, wherein a school server sends exercise data to a computer of a student who is a client by using a computer network, and the student can directly write answers into the exercise data on the screen of the computer and return the data to the server's computer.

7. An Internet learning support system by a computer system according to claim 1, further comprising entrance processing, wherein
in addition to directly accepting entrance formalities at the window of the school, the entrance processing accepts the entrance formalities by e-mail or facsimile, converts the contents of the entrance formalities into a text format and imports this data into a database.

8. An Internet learning support system by a computer system according to claim 1 or 7, wherein said Internet learning support system by a computer system provides learning support to computers of students, who are clients, from a school computer, and the computer at the server side that executes teaching material selection processing, exercise data sending processing, answer data receiving processing, correcting processing, corrected data saving processing, and corrected data sending processing has databases including a teaching materials database, a student system information database, a student results database, and a sending history database, where
information stored in the teaching materials database includes:
1. subject names (names of class materials categorized by pedagogical objective and method and degree of the students' development), 2. unit names (items to be learned in each subject), 3. field names (items to be learned in each unit), 4. levels (difficulty of questions in teaching materials), 5. question ID codes, 6. question files, 7. answer files, 8. the order of priority (the order of extraction of questions in teaching materials);
information stored in the student system information database:
1. student ID codes, 2. student names, 3. students' facsimile numbers, 4. students' facsimile ID codes, and 5. students' e-mail addresses;
information stored in the student results database includes:
1. student ID codes, 2. student names, 3. subject names (names of class materials categorized by pedagogical objective and method and degree of the students' development), 4. unit names (items to be learned in each subject), 5. field names (items to be learned in each unit), 6. scores, and 7. finished question ID codes;
information stored in the sending history database includes:
1. student ID codes, 2. student names, 3. correction dates, 4. subject names, 5. unit names, 6. field names, 7. corrector names, and 8. sending condition (distinction between unsent and sent).
